(19) United States
(12) Patent Application Publication
(10) Pub. No.: US 2016/0348674 A1
(43) Pub. Date: Dec. 1, 2016

(54) HYDRAULIC SYSTEM WITH A DRAIN HOUSING

(71) Applicant: POCLAIN HYDRAULICS INDUSTRIE, Verberie (FR)

(72) Inventors: Stephane VIDAL, Longueil Sainte Marie (FR); Jeremie MULOT, Le Fay Saint Quentin (FR); Gery DEPIERRE, Lacroix Saint Ouen (FR)

(73) Assignee: POCLAIN HYDRAULICS INDUSTRIE, Verberie (FR)

(21) Appl. No.: 15/104,248

(22) PCT Filed: Dec. 16, 2014
(86) PCT No.: PCT/FR2014/053355

§ 371 Date: Jun. 14, 2016

(30) Foreign Application Priority Data
Dec. 17, 2013 (FR) 1362756

(51) Int. Cl. F04C 15/00; F16J 15/00

(52) U.S. Cl. CPC F04C 15/0038; F16J 15/004

(57) ABSTRACT

The hydraulic system comprises a casing (10) in which there are disposed hydraulic apparatus (12), a shaft (14) engaged in the casing, and a sealing device (16) between the shaft and the casing. The sealing device comprises first and second sealing elements (20, 22) disposed in succession on the shaft while forming between them a discharge chamber (24) connected to a drain (26), the first sealing element being situated between the discharge chamber and the internal space (11) of the casing. Between the discharge chamber (24) and the internal space (11) of the casing, the hydraulic system has a communication duct (28) in which a calibrated jet nozzle (30) is disposed.

### TECHNICAL FIELD

The present disclosure relates to a hydraulic system comprising a casing in which there are disposed hydraulic apparatus, a shaft engaged in the casing, and a sealing device between the shaft and the casing, the sealing device comprising first and second sealing elements disposed in succession on the shaft while forming between them a discharge chamber connected to a drain, the first sealing element being situated between the discharge chamber and the internal space of the casing.

### BACKGROUND

A system of this type is known from the Applicant's Patent Application FR 2 967 228. As indicated in that prior application, the presence of the first sealing element makes it possible to protect the second sealing element from pressure peaks that can occur in the internal space of the casing. The discharge chamber serves as a buffer space, in particular for collecting fluid coming from leaks at the first sealing element, such leaks occurring when such pressure peaks occur. Connecting the discharge chamber to a drain makes it possible to avoid increases in pressure in said chamber and thus to improve the protection of the second sealing element further.

For example, the hydraulic apparatus may comprise a cylinder block, a cam, and a distributor, in such manner that, when considered with the casing, it forms a hydraulic motor. For deactivating such a hydraulic motor, the pistons, which are mounted to slide in the cylinders of the cylinder block, can be retracted into said block so as to cease to be in contact with the cam, thereby “declutching” the motor. Such declutching may be assisted or caused by pressurizing the internal space of the casing. Unfortunately, when it is desired to reactivate the motor, and thus to cause the pistons to come out of their cylinders so as to put them back into contact with the cam, thereby “clutching” the motor, the pressure in the internal space can increase suddenly because of the pistons coming out of their cylinders, thereby giving rise to a pressure peak.

As indicated, the presence of two sealing elements, between which a discharge chamber connected to a drain is disposed, makes it possible to guarantee that the sealing is durable and reliable despite such pressure peaks. In addition, in order to remove the fluid present in the internal space of the casing, a flushing drain is also necessary. The drain of the discharge chamber and the flushing drain must, in general, both be formed by going through a stator element. Such multiple holes to be bored generate costs. In addition, when the shaft that is engaged in the casing is a stator element, the drains generally go through that shaft, which can be weakened as a result, in particular since ducts necessary for forming feed and exhaust means for the hydraulic apparatus must often also be provided in the same shaft.

Another example of hydraulic apparatus is a hydraulic brake using brake disks or the like that are continuously urged back into braking contact but that can be driven out of contact to prevent braking by hydraulic fluid pressure. Similarly, in that type of apparatus, pressure peaks can occur, e.g. at the time at which the fluid is injected to drive the disks out of contact to cause current braking to cease. Similarly, with that other type of apparatus, a flushing drain must be provided in addition to the drain of the discharge chamber, in order to enable the fluid present in the internal space of the casing to be removed.

Generally, in apparatus of the above-mentioned type, flushing the internal space of the casing makes it possible to change, to a certain extent, the hydraulic fluid contained in the casing, e.g. so as to avoid it overheating during prolonged operation of the apparatus. The flushing flow rate that is necessary is determined as a function of the use made of the apparatus.

### SUMMARY

An object of embodiments of the present disclosure is to simplify the known system, having a discharge chamber and a drain, by making it possible to flush the internal space of the casing reliably, without having to use a specific flushing drain.

This object is achieved by that fact that, between the discharge chamber and the internal space of the casing, the hydraulic system has a communication duct in which a calibrated jet nozzle is disposed.

Thus, the communication duct, associated with the drain to which the discharge chamber is connected, makes it possible to remove the fluid contained in the internal space of the casing, thus acting as a flushing drain. In spite of the presence of the first sealing element, a continuous leak is thus organized between the internal space of the casing and the discharge chamber. However, in order for the first sealing element to perform fully its function of protecting the second sealing element from pressure peaks, the communication duct is equipped with a calibrated jet nozzle. This calibrated jet nozzle makes it possible to determine accurately the head loss between the internal space of the casing and the discharge chamber, in such manner that the pressure peaks occurring in the internal space of the casing do not generate, in the discharge chamber, increase in pressure that might damage the second sealing element. Thus, the first sealing element continues to perform fully its function of protecting the second sealing element. In addition, the cross-sectional area of the calibrated jet nozzle is determined in such manner that said nozzle can make it possible to remove the fluid contained in the internal space of the casing at a flow rate appropriate for achieving effective flushing.

By choosing a calibrated jet nozzle, it is also possible to control the pressure in the casing, while flushing is taking place.

It is possible for the calibrated jet nozzle to be disposed at some distance from the shaft, in order to avoid the risks of said jet nozzle becoming clogged. Such risks are, for example, due to wear dust generated by friction between the shaft and the various elements co-operating with it.

In an embodiment, the drain has a through cross-sectional area greater than the cross-sectional area of the calibrated jet nozzle, and preferably at least 30% greater than the cross-sectional area of the calibrated jet nozzle.

Since it has a through cross-sectional area greater than the cross-sectional area of the calibrated jet nozzle, the drain performs effectively its function of removing the fluid present in the discharge chamber, thereby avoiding any excessive pressure in said chamber.

In an embodiment, the first sealing element comprises an annular sealing gasket and a gasket support that is fastened to the casing.

In which case, it can be chosen for the calibrated jet nozzle to be disposed in a hole bored through the gasket support.

The gasket support is a part that is easy to machine, and that is subjected to relatively little stress. Therefore, the presence of a hole through this part does not significantly affect its strength. In addition, the jet nozzle can thus be placed without affecting the overall size of the assembly, and by means of simple mounting operations, performed on a part that is easy to handle.

In addition, when the hydraulic apparatus includes a rotor, the gasket support may itself be constrained in rotation with said rotor. Thus, by rotating, the calibrated jet nozzle situated in the gasket support makes it possible to perform effective flushing of the entire discharge chamber, thereby avoiding any increase in temperature inside said chamber.

According to a possible characteristic, the hole is inclined relative to the axial direction of the shaft.

As explained below, the inclination of the hole may be chosen in such manner that the fluid exiting from the communication duct does not affect the second sealing element. In addition, this inclination may be chosen to avoid the risks of the fluid stagnating in the discharge chamber, thereby preventing the temperature of the fluid in said chamber from rising.

For example, the hole is inclined such that its end that is situated beside the discharge chamber is closer to the shaft than its end that is situated beside the internal space of the casing.

This inclination is particularly advantageous when the hydraulic apparatus includes a rotor portion, since the centrifugal forces tend to cause the fluid to swirl in the discharge chamber.

In an option, the gasket support has a bearing surface for the second sealing element.

In which case, the gasket support also serves to hold the second sealing element in position.

In an embodiment, the system further comprises a friction ring mounted in tight-fitting manner on the shaft and having an external track that co-operates with at least one of the sealing elements, and preferably with the first sealing element, and the friction ring is provided with a hole that forms a portion of the drain.

The external track of the friction ring forms an appropriate sealing surface for the sealing element(s) with which it co-operates.

It is also possible for the friction ring to form a support ring for a bearing for supporting the relative rotation between the shaft and the casing.

However, in another embodiment, such a friction ring is not provided, and both of the sealing elements co-operate directly with the shaft, the surface of which forms a sealing surface.

In an embodiment, the shaft has only two ducts in fluid connection with the internal space of the casing, namely a fluid feed axial duct for feeding fluid to the internal space of the casing, and an exhaust axial duct that forms a portion of the drain.

A duct “in fluid connection” means a duct having the function of enabling fluid to flow between the internal space of the casing and some other space (e.g. a pressure-free reservoir or a pressure source).

The machining of the shaft is simplified relative to the prior art, in which the presence of a drain that is specific to flushing is also necessary, so that three ducts in fluid connection with the internal space of the casing are present in the prior art. The shaft is thus less weakened than in the prior art.

In an embodiment, the hydraulic apparatus comprises a cylinder block, a cam, and a fluid distributor

In which case, considered together with the casing, said apparatus forms a hydraulic motor. In particular, it is a motor having radial pistons and high working output torque, e.g. for driving the wheel of a vehicle. The feed and exhaust ducts of said motor, like any control ducts serving to cause the cylinder capacity of the motor to be changed, are then not ducts that are in fluid connection within the meaning of the definition given above.

In an embodiment, the jet nozzle points in such manner as not to direct its output jet inside the discharge chamber towards the second sealing element.

### BRIEF DESCRIPTION OF THE DRAWINGS

The present disclosure can be well understood and its advantages appear more clearly on reading the following detailed description of an embodiment shown by way of non-limiting example. The description refers to the accompanying drawings, in which:

FIG. 1 is an axial section view of a hydraulic system of embodiments of the disclosure;

FIG. 2 is an enlarged view of zone II of FIG. 1, to which zone the disclosure relates more particularly;

FIG. 3 is a view analogous to FIG. 2, but showing a variant, while the system is being assembled;

FIG. 4 is a view analogous to the FIG. 1 view, but showing a variant embodiment; and

FIG. 5 is a view analogous to the FIG. 2 view, but showing another variant.

### DETAILED DESCRIPTION

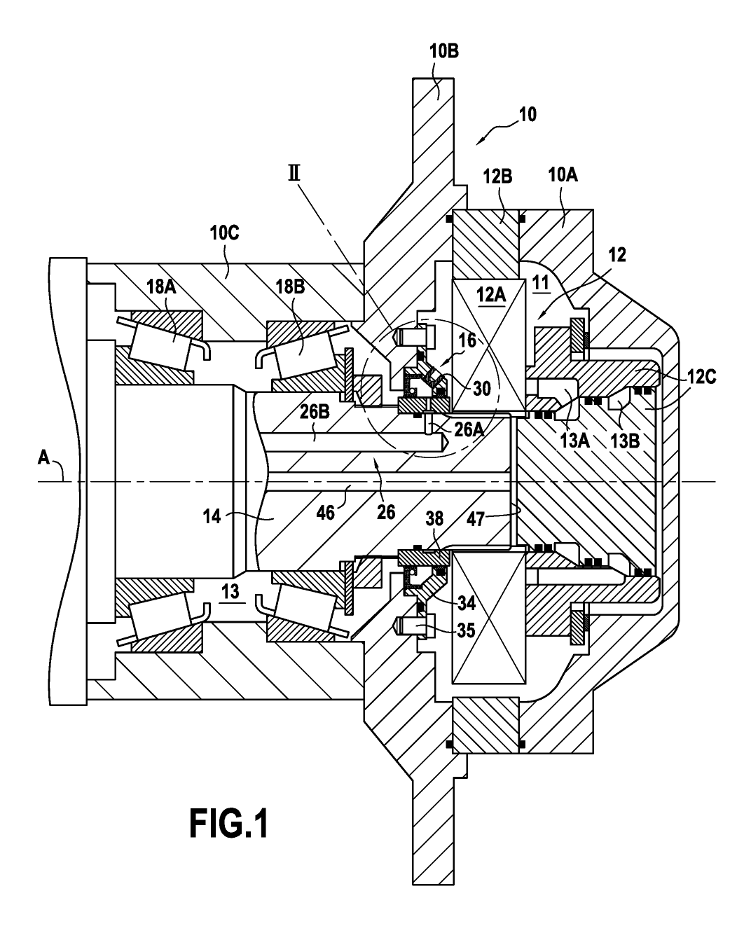

FIG. 1 shows a hydraulic system comprising a casing 10 in which hydraulic apparatus 12 is disposed, a shaft 14 engaged in the casing, and a sealing device 16 between the shaft and the casing. In this example, the hydraulic apparatus 12 comprises a cylinder block 12A, a cam 12B, and a fluid distributor 12C. Therefore, together with the casing, it forms a hydraulic motor or a hydraulic pump. In particular, it may be a hydraulic motor having radial pistons. In a manner known per se, the cylinders of the cylinder block are fed with fluid from a fluid distributed by the distributor, via grooves, some of which are shown and designated by references 13A and 13B. The distributor is itself connected to fluid feed and fluid exhaust main ducts that are not shown. In particular, this apparatus may be of the type having a stationary cylinder block and a rotary casing, in which case the feed and exhaust ducts advantageously go through the shaft 14.

The cam 12B forms a portion of the casing 10, which casing also includes a portion 10A situated around the distributor 12C, and a portion 10B forming, for example, a flange for connecting to a member driven by the motor, e.g. the hub of a wheel. On the opposite side of the hydraulic apparatus 12, the casing is extended by a portion 10C that may, for example, be engaged in the hub of a wheel. The casing and the shaft 14 are mounted to move in rotation relative to each other. For this reason, they co-operate with each other via bearings 18A and 18B that, in this example, are received in the portion 10C of the casing. In known manner, these bearings may be conical roller bearings. As indicated above, the system may serve to drive a member such as a wheel, in which case the shaft may be the spindle of a wheel. As can be seen in FIG. 1, the shaft is constrained in rotation with the cylinder block 12A, via fluting, in a manner known per se. Thus, in this example, the shaft and the cylinder block are both stator elements, while the casing is a rotor element.

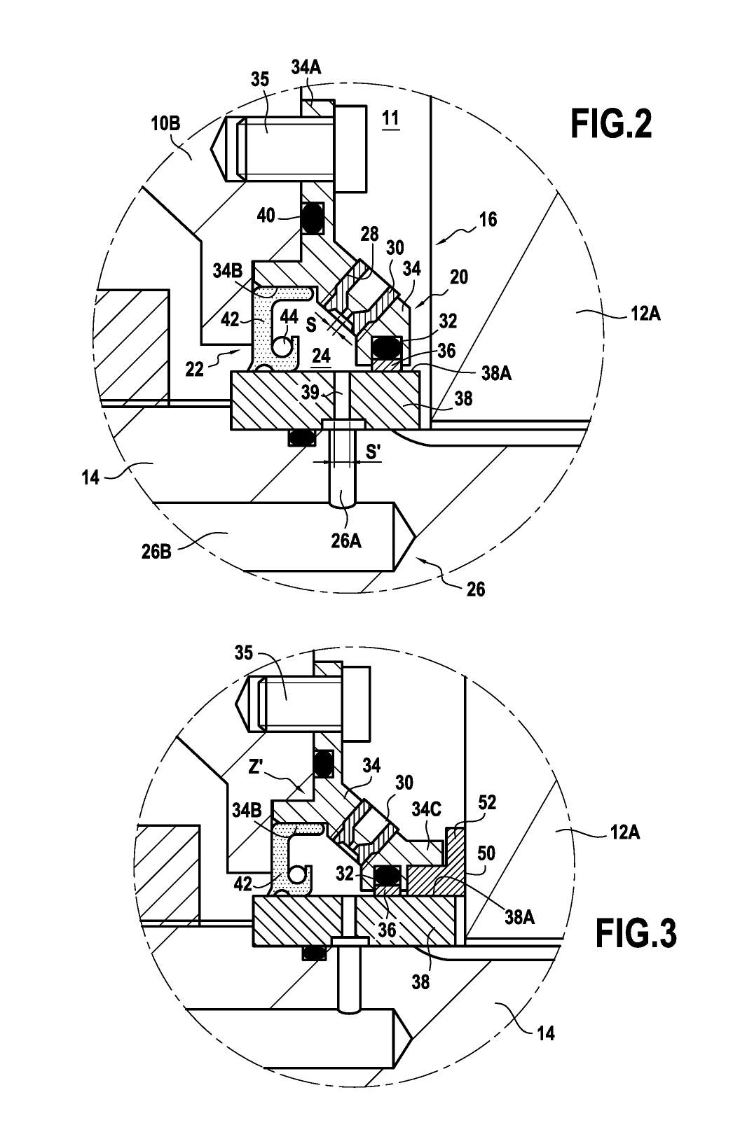

As can be seen more clearly in FIG. 2, the sealing device 16 comprises a first sealing element 20 and a second sealing element 22 that are disposed in succession on the shaft 14. A discharge chamber 24 is provided between the two sealing elements. The first sealing element 20 is closer to the hydraulic apparatus 12 than the second sealing element 22. The discharge chamber 24 is connected to a drain 26. In particular, this drain may be provided in or on the shaft 14, in particular when said shaft is a stator element. In the example shown, said drain comprises a radial duct segment 26A and an axial duct segment 26B, the segment 26A establishing the connection between the discharge chamber 24 and the axial segment 26B. Other embodiments of the drain are possible, e.g. of the type of those described in Document FR 2 967 228. It can be understood that the sealing device 16 serves to isolate in sealed manner the internal space of the casing 11 from the remainder of the hydraulic system, in particular the space 13 in which the bearings 18A and 18B are received.

It can be see, in particular in FIG. 2, that the system has a communication duct 28 establishing a fluid connection between the internal space 11 of the casing and the discharge chamber 24. A calibrated jet nozzle 30 is disposed in the duct 28.

It can be seen that the cross-sectional area S of the calibrated jet nozzle is less than the cross-sectional area S′ of the drain 26. In particular, the cross-sectional area S′ is at least 30% greater than the cross-sectional area S.

In an embodiment, it is desired to make provision for the pressure inside the discharge chamber to be less than 3 bars, and preferably less than 1 bar, e.g. about 0.5 bars, even though the pressure peaks in the casing can be as high as about 10 bars or more, and even though the normal pressure in the casing, outside the pressure peaks, can be about 1.5 bars. The difference in cross-sectional area of about 30% makes it possible to obtain the desired difference in pressure between the internal space of the casing and the discharge chamber.

The first sealing element 20 comprises an annular sealing gasket 32 and a gasket support 34 that is fastened to the casing 10. In the particular example shown, the first sealing element further comprises an annular pad 36. More precisely, the annular gasket 32 and the annular pad 36 are both disposed in an annular groove of the support 34, in such manner that the pad projects slightly from said groove. It is the pad 36 that establishes an area of contact with the shaft 14 or, as in the example shown, with a friction ring 38 that is mounted in tight-fitting manner on said shaft. The pad co-operates with the external track 38A of said ring that is formed on the outside axial periphery of said ring.

The friction ring 38 is a piece of very hard material, that has low roughness, that is machined to a very high level of quality, and that is mounted on the shaft in a known manner, so as to form a friction track having a surface state appropriate for the contact elements of the first and second sealing elements. A separately mounted friction ring also offers the advantage that it can be changed when worn in order to maintain the system.

Naturally, it is possible to use a configuration without such a separate friction ring 38, by forming an appropriate friction surface directly on the shaft 14. For fastening the gasket support to the casing 10 or, more precisely to the portion 10B of the casing, said gasket support has, in this example, a radial collar 34A, the fastening means being, in this example, screws 35 passing through holes in said collar and screwed into the bores in the portion 10B of the casing. In the example shown, an additional sealing gasket 40 establishes sealing between the contact surfaces of the collar 34A and the portion 10B of the casing.

The second sealing element 22 has a lip-seal gasket 42 with a reinforcing rod 44 that keeps it pressed against the external track of the friction ring 38.

It should be noted that the gasket support 34 has a bearing surface 34B for the second sealing element. In this example, this axial bearing surface is formed by the inside face 34B of an axial extension of the support 34, with which the outside axial periphery of the gasket 42 co-operates.

It can be seen that the calibrated jet nozzle 30 is disposed in a hole bored through the gasket support. Thus, the communication duct 28 is, in this example, formed by said hole. It can also be seen that said hole is inclined relative to the axial direction A of the shaft 14. More precisely, the inclination of said hole 28 is such that its end that is situated beside the discharge chamber 24 is closer to the shaft 14 than its end that is situated beside the internal space 11 of the casing. In the example shown, the hole 28 is rectilinear and its inclination relative to the axial direction A is about 45°. The hole 28 is bored such that it is tapped, the jet nozzle 30 being screwed into its thread. The jet nozzle may also be force-fitted, in tight-fitting manner, or be formed directly by boring through the gasket support, preferably to form a stepped hole, its small cross-section thus being formed with low tolerance.

Mention is made above of the friction ring 38, with which at least one of the sealing elements 20 and 22 co-operates. In this example, both of the sealing elements co-operate with the external axial track 38A of said ring, which therefore delimits the discharge chamber 24 on its axially inner side. It can also be seen that this ring 38 has a hole 39 that forms part of the drain 26. In this example, it is the cross-sectional area of this hole 39 that defines the cross-sectional area S′ of the drain, the hole 39 forming a portion of the above-mentioned radial segment 26A of the drain.

It can also be seen in FIG. 1 that the shaft 14 has a duct 46 that opens out into the internal space of the casing. This duct communicates with a space 47 provided between the shaft 14 and the internal portion of the distributor 12C. This space 47 communicates in a manner known per se with the internal space 11 of the casing, either via a hole through the internal portion of the distributor 12C, or via clearance provided over a portion of the fluting between the shaft 14 and the cylinder block 12A. In this example, the duct 46 is an axial duct for feeding fluid towards the internal space of the casing, in order to pressurize said casing, e.g. so as to clutch the pistons of the cylinder block 12A. In addition, the shaft has an axial exhaust duct forming the portion 26B of the drain 26. As indicated above, by means of the invention, the drain 26 serves not only to avoid increases in pressure in the chamber 24, but also to remove fluid for flushing the hydraulic apparatus. Thus, for the fluid connection with the internal space of the casing, the shaft has only the two ducts 46 and 26.

In order to obtain flushing of the casing, it is thus possible to apply moderate fluid pressure via the duct 46, thereby generating a flushing flow rate set by the jet nozzle 30 towards the drain 26.

Similarly, in a manner known per se, the user can generate a temporary limited increase in pressure if desired, at the time at which the pistons come out for clutching, by draining the casing via the jet nozzle 30. FIG. 3 shows a variant embodiment, in which a centering ring 50 is used for mounting the gasket support 34. In FIG. 3, the elements common to FIGS. 1 and 2 are designated by the same references.

In this example, the centering ring 50 firstly co-operates with an axial bearing surface of the gasket support 34. Secondly the ring 50 is held in position relative to the axial surface of the shaft 14. More precisely, in the variant shown in FIG. 3, the gasket support 34 has an extension, pointing towards the hydraulic apparatus and in the form of an axial skirt 34C, in such manner that a space is provided between the inside face of said skirt and the friction track 38A of the ring 38. The centering ring is inserted into this space, and therefore co-operates with the inside face of the skirt 34C and with the friction track 38A. In addition, in this example, the centering ring has a flange portion 52 that facilitates taking hold of it. Once the gasket support has been mounted in this way, the centering ring 50 may be removed.

If the friction ring 38 is absent, the centering ring 50 could co-operate directly with the outside periphery of the shaft that forms the axial centering surface.

Other embodiments of the centering ring are possible, e.g. those described in Patent Application FR 2 967 201.

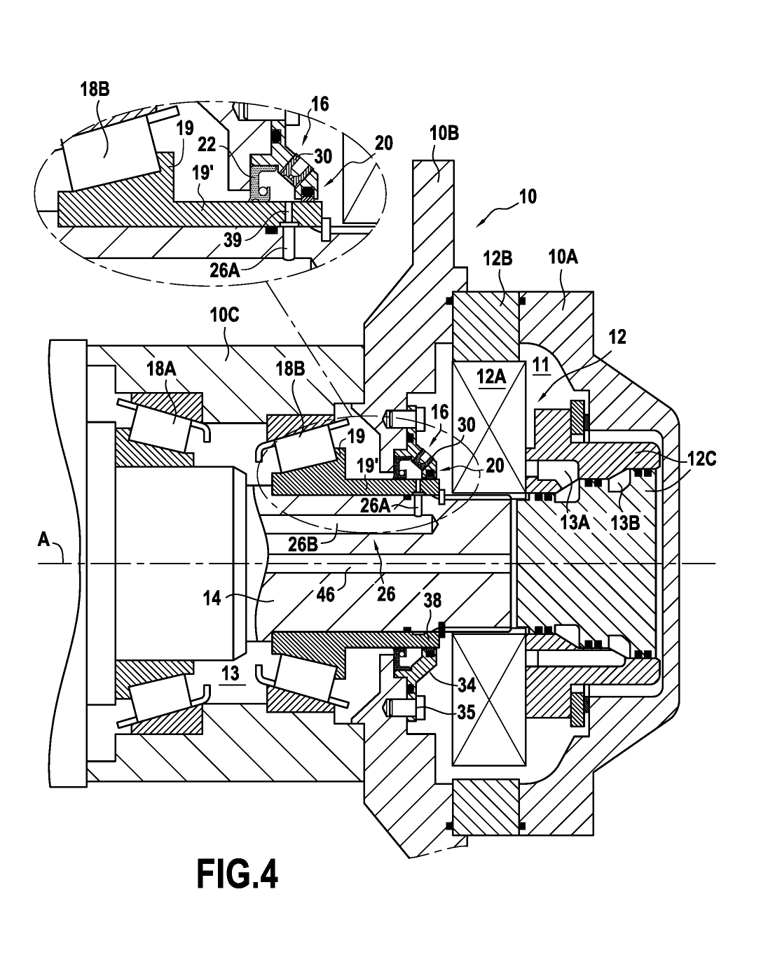

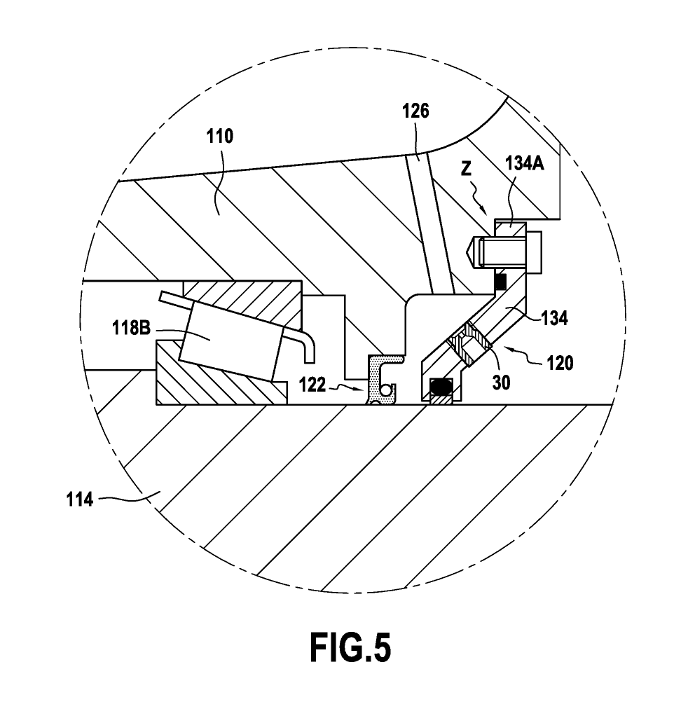

In the examples shown in FIGS. 1 to 3, the sealing elements co-operate with the friction ring 38, while the bearings have their own support rings. In the variant shown in FIG. 4, the support ring of the bearing 18B that is closer to the sealing elements 20 and 22 also serves as a friction ring, as can be seen more clearly in the enlarged zone. Said support ring 19 has an axial extension 19′ that serves a friction ring. In particular, it can be noted that at least the second sealing element 22 co-operates with the surface of said extension 19′ that forms a friction track. In this example, both of the sealing elements 20 and 22 co-operate with said friction track. The extension 19′ is also provided with a hole 39 that forms a portion of the drain.

In the above-described figures, the shaft 14 forms a core portion for the hydraulic system, and preferably serves as a stator whereas said casing 10 is a rotary casing. As indicated above, the shaft is, for example, a spindle of a wheel.

However, the disclosure also applies to when the shaft is a rotor portion, while the casing is a stator portion. This is what is shown in FIG. 5, in which only a portion of the system is shown. This figure shows the casing 110 disposed around the shaft 114, and a bearing 118B. Another bearing may be situated on the left of the bearing 118B, i.e. on the side opposite from the casing. If the hydraulic apparatus is of the hydraulic motor or pump type, a cylinder block may be provided in the casing 110, on the right of the figure. Two sealing elements 120 and 122 that are analogous to the above-described sealing elements separate the bearing 118B from the internal space of the casing 111. The gasket support 134 that is part of the first sealing element is equipped with a jet nozzle 30 as in the above-described variants. The support 134 co-operates firstly with the shaft 114 via an arrangement having an annular gasket and a pad, and secondly with the casing 110, via an additional gasket. A flange portion 134A of the gasket support 134 enables it to be fastened to the casing 110. To drain the discharge chamber 124 provided between the two sealing elements 120 and 122, a drain 126 is provided in the casing 110.

It can also be noted in FIG. 5 that the jet nozzle 30 is pointing in such manner that it does not direct its output jet towards the second sealing element 122, thereby avoiding disturbance at said sealing element, it being possible for such disturbance to affect the sealing adversely. Naturally, jet nozzle orientation of the same type is compatible with the variants shown in FIGS. 1 to 4, e.g. by inclining the jet nozzle in such manner as to place it almost perpendicularly to the axis of the shaft 14.

In the variants shown, the gasket support is fastened to the casing by screws. Naturally, it is possible to use other modes of fastening. Indeed, if the area of bearing contact between the gasket support and the casing is sufficient in the zone Z indicated in FIG. 5, it is possible to provide a force-fitting mounting configuration by engagement under force between the cylindrical surface of the gasket support and the bearing surface formed on the casing. Similarly, for the variant shown in FIG. 3, engagement under force in the zone Z′ of cylindrical bearing between the gasket support and the casing is also possible, in which case, the fastening screws 35 can be omitted.

If such a force-fitting mounting configuration is used, the sealing between the gasket support and the casing may be provided directly by the contact of the above mentioned cylindrical bearing surfaces, in which case it is possible to omit the additional gasket 40.

1-13. (canceled)

14. A hydraulic system comprising:
a casing in which there are disposed hydraulic apparatus, a shaft engaged in the casing, and a sealing device between the shaft and the casing,
the sealing device comprising:
first and second sealing elements disposed in succession on the shaft while forming between them a discharge chamber connected to a drain, the first sealing element being situated between the discharge chamber and the internal space of the casing and
a communication duct in which a calibrated jet nozzle is disposed being arranged between the discharge chamber and the internal space of the casing.

15. The hydraulic system as claimed in claim 14, wherein the drain has a through cross-sectional area greater than a cross-sectional area of the calibrated jet nozzle.

16. The hydraulic system as claimed in claim 14, wherein the drain has a through cross-sectional area at least 30% greater than a cross-sectional area of the calibrated jet nozzle.

17. The hydraulic system as claimed in claim 14, wherein the first sealing element comprises a sealing gasket and a gasket support fastened to the casing.

18. The hydraulic system as claimed in claim 17, wherein the calibrated jet nozzle is disposed in a hole bored through the gasket support.

19. The hydraulic system as claimed in claim 18, wherein the hole is inclined relative to the axial direction of the shaft.

20. The hydraulic system as claimed in claim 19, wherein the hole is inclined in such manner that an end of said hole situated beside the discharge chamber is closer to the shaft than another end of said hole situated beside the internal space of the casing.

21. The hydraulic system as claimed in claim 17, wherein the gasket support has a bearing surface for the second sealing element.

22. The hydraulic system as claimed in claim 18, wherein the gasket support has a bearing surface for the second sealing element.

23. The hydraulic system as claimed in claim 14, further comprising a friction ring mounted in tight-fitting manner on the shaft and having an external track that co-operates with at least one of the sealing elements and the friction ring is provided with a hole that forms a portion of the drain.

24. The hydraulic system as claimed in claim 23, wherein the friction ring co-operates with the first sealing element.

25. The hydraulic system as claimed in claim 23, wherein the friction ring forms a support ring for a bearing.

26. The hydraulic system as claimed in claim 14, wherein the shaft has only two ducts in fluid connection with the internal space of the casing, namely a fluid feed axial duct for feeding fluid to the internal space of the casing, and an exhaust axial duct that forms a portion of the drain.

27. The hydraulic system as claimed in claim 14, wherein the hydraulic apparatus comprises a cylinder block, a cam and a fluid distributor.

28. The hydraulic system as claimed in claim 14, wherein the jet nozzle points in such manner as not to direct its output jet inside the discharge chamber towards the second sealing element.
